(19) United States
(12) Patent Application Publication
(10) Pub. No.: US 2010/0193399 A1
(43) Pub. Date: Aug. 5, 2010

(54) NOVEL CRACKING CATALYTIC COMPOSITIONS

(75) Inventors: Paul O'connor, Hoevelaken (NL); King Yen Yung, Almere (NL); Avelino Corma Canos, Valencia (ES); Elbert Arjan De Graaf, Amserdam (NL); Erja Päivi Helena Rautiainen, Leusden (NL)

Correspondence Address: Albemarle Netherlands B.V.;Patent and Trademark Department, 451 Florida Street, Baton Rouge, LA, 70801, US

(73) Assignee: Albemarle Netherlands B.V., Amersfoort (NL)

(21) Appl. No.: 12/158,982

(22) PCT Filed: Dec. 22, 2006
(86) PCT No.: PCT/EP06/70204

§ 371 Date: Dec. 8, 2008

(30) Foreign Application Priority Data
Dec. 22, 2005 (EP) 05112841.1

(51) Int. Cl. C10G 11/04; B01J 21/06; C10G 51/00; C10L 1/04

(52) U.S. Cl. 208/16; 502/242; 208/121; 208/59

(57) ABSTRACT

Novel catalytic compositions for cracking of crude oil fractions are disclosed. The catalytic compositions comprise a basic material. When used in a cracking process, preferably a FCC process, the resulting LCO and HCO fractions have desirably low aromatics levels. Further disclosed is a one-stage FCC process using the catalytic composition of the invention. Also disclosed is a two-stage FCC process for maximizing the LCO yield.

### BACKGROUND OF THE INVENTION

Crude oil is a complex mixture of hydrocarbons. In a refinery, crude oil is subjected to distillation processes to make a first separation by boiling point. One of the main fractions obtained in this process is Vacuum Gas Oil (VGO), which is commonly treated further in a cracking process, in particular a fluid catalytic cracking (FCC) process. Other feedstocks for cracking process include hydrotreated VGO and atmospheric resid.

Cracking is the process by which the relatively large molecules in a feedstock such as VGO are converted to lighter fractions. This may be done by heating the VGO under non-oxidizing conditions, so-called thermal tracking. If done in the presence of a catalyst, the cracking process may be carried out at a lower temperature.

Almost all catalytic cracking is presently carried out in a fluid catalytic cracking process, or FCC process. In this process small particles of catalytic material are suspended in a lifting gas. The feedstock is sprayed onto the catalyst particles through a nozzle. The feedstock molecules are cracked on the catalyst particles. Products and catalyst particles are carried by the lift gas through the reactor. After the reaction the catalyst particles are separated from the reaction products, and sent to a stripping section where the catalyst is subjected to a severe steam treatment to remove as much of the hydrocarbon molecules as possible. After the stripper the catalyst particles are transferred to a regenerator where coke that was formed during the reaction is burned off, and the catalyst is regenerated for further use.

The catalyst in a standard FCC process comprises an acidic zeolite, such as Y-zeolite or a stabilized form of a Y-zeolite. Generally, the Y-zeolite is combined with a matrix material, which may be alumina or silica-alumina. The catalyst may further comprise components for improving its resistance against poisoning by metal contaminants of the feedstock, in particular nickel and vanadium. Other components may be present to capture sulfur from the feedstock. The actual cracking process takes place on the acidic sites of the zeolite and of the matrix.

The product of the FCC process is subsequently split into several fractions. Dry gas is a low molecular weight fraction that does not liquefy when compressed at ambient temperature (hence the term dry). The dry gas comprises hydrogen, methane, ethane and ethene. The liquefied petroleum gas fraction consists of compounds that are in the gas form at room temperature, but liquefy when compressed. This fraction comprises predominantly propane, propene, butane, and its mono- and di-olefins.

The gasoline fraction may have a boiling point range of from about the boiling point of nC₅ (36° C.) to about 220° C. The endpoint may be varied to meet specific objectives of the refining process. The gasoline fraction forms the basis of commercial gasoline sold as a fuel for vehicles equipped with an Otto engine. One of the main requirements for the gasoline fraction is that it has as high and octane number as possible. Straight-chain hydrocarbons have a low octane number; branched-chain hydrocarbons have a higher octane number, with the octane number further increasing with the number of alkyl groups. Olefins have a high octane number, and aromatics have an even higher octane number,

The light cycle oil fraction, or LCO fraction, forms the basis for fuel oil. It is the fraction having a boiling point above that of the gasoline fraction and lower than about 340° C. Hydrotreatment is required to convert the LCO to diesel fuel.

The quality of the LCO, in terms of its nitrogen content, its sulfur content and its aromatics content, determine the rate at which the LCO fraction may be blended into the feed that will be converted to diesel fuel in the hydrotreatment process. It is important for diesel fuel to have as high a cetane number as possible. Straight-chain hydrocarbons have a high cetane number; branched-chain hydrocarbons, olefins and aromatics have very low cetane numbers.

The product fraction having a boiling point above 340° C. is referred to as “bottoms”. Although it is desirable to operate at the highest possible conversion, the composition of the product mix is adversely affected by operating at high conversion rates. For example, the coke yield increases as the conversion increases. Coke is a term describing the formation of carbon and pre-carbon deposits onto the catalyst. Up to a point, the formation of coke is essential to the cracking process as it provides the energy for the endothermic cracking reaction. A high coke yield is, however, undesirable, because it results in a loss of hydrocarbon material and disruption of the heat balance as burning off of the coke produces more heat than the process requires. Under these conditions it may be necessary to release part of the produced heat, for example by providing a catalyst cooling device in the regenerator, or to operate the process in a partial combustion mode.

The fraction of the bottoms having a boiling point between about 340 and 496° C. is referred to as heavy cycle oil, or HCO.

In general the most desirable fractions of the FCC products stream are the light olefins, the gasoline fraction, and the LCO fraction. The desired split between the last two is determined by the ratio between the number of diesel powered vehicles and gasoline powered vehicles, and by the seasonal demand for heating fuel.

Because of the need for a high cetane number, it is desirable to keep the amount of aromatics in the light cycle oil fraction as low as possible. In terms of their boiling points, a large portion of any aromatics formed will end up in the light cycle oil fraction. It is therefore desirable to minimize the amount of aromatics that is formed in the cracking process.

Lighter aromatics, such as benzene and toluene, become part of the gasoline fraction of the product stream. Because of their high octane numbers, the aromatic components of gasoline might be considered desirable. However, because of a growing concern about the toxicity of aromatic compounds, it has become desirable to form a gasoline fraction that is low in aromatics content. The octane number of the gasoline pool of the refinery can be increased by alkylation of the butylenes and the isobutane streams from the FCC. Additional butane may be needed from other refinery processes. The high quality alkylate has also a desirable very low aromatics content, thereby reducing the aromatics content of the total gasoline pool.

US 200510121363 (Vierheilig et al.) discloses an FCC process wherein hydrotalcite-like compounds are used as an additive for reducing sulfur in gasoline. The hydrotalcite-like compounds are used in combination with an acidic zeolite, such as E-cat.

U.S. Pat. No. 3,904,550 (Pine) discloses a catalyst support comprised of alumina and aluminum phosphate. The support is used for catalysts useful in hydrodesulfurization and hydrodenitrogenation processes. The support material may also be combined with acidic zeolitic materials for use in hydrocracking or catalytic cracking.

It is desirable to develop a catalyst for use in a cracking process for the cracking of FCC feed stock whereby the formation of aromatics is reduced as compared to conventional FCC processes. It is a particular objective of the present invention to provide a cracking process producing a light cycle oil fraction having a low aromatics content.

### SUMMARY OF THE INVENTION

The present invention relates to a catalytic composition for use in an FCC process, said catalytic composition having basic sites and, optionally, acidic sites, with the proviso that, if that catalyst comprises both acidic and basic sites, the number of basic sites is significantly greater than the number of acidic sites. The catalytic composition comprises less than about 3% of an acidic zeolite, and is preferably substantially free of acidic zeolite.

Another aspect of the present invention is an FCC process wherein a feedstock is contacted with the catalytic composition as defined herein.

Yet another aspect of the present invention is a two-stage cracking process. In the first stage cracking conditions are set to minimize the formation of aromatics and maximize the yield of LCO. In the second stage bottoms conversion is maximized. The net effect will be a high yield of low aromatics LCO. The process set-up is very flexible, by changing operating conditions the unit can be changed from maximum distillate mode to maximum gasoline+LPG mode.

The catalyst used can be above mentioned conventional standard acidic zeolite, such as Y-zeolite or a stabilized form of a Y-zeolite, containing FCC catalysts. Preferably, the Y-zeolite is combined with a matrix material, which may be alumina or silica-alumina. Optionally the catalyst may further comprise components for improving its resistance against poisoning by metal contaminants of the feedstock, in particular nickel and vanadium. Other components may be present to capture sulfur from the feedstock. This conventional catalyst is characterized by high cracking activity and promotes hydrogen transfer causing aromatic formation in the gasoline and LCO boiling range.

In a preferred embodiment of the two-stage cracking process the catalyst is the catalytic composition as defined herein.

### BRIEF DESCRIPTION OF THE DRAWINGS FIGURES

FIG. 1 shows a two-stage FCC cracking process for maximum LCO yield and maximum cetane number.

FIG. 2 shows the conversions and yield structures of two different feedstocks in the two-stage FCC process.

FIG. 3 shows the aromatic contents of different product streams obtained in the two-stage FCC process.

### DETAILED DESCRIPTION OF THE INVENTION

The present invention is based on the discovery that a catalyst having basic sites catalyzes the cracking reaction via a radical, or one-electron, mechanism. This is similar to the mechanism as occurs in thermal cracking. The difference with thermal cracking is that the presence of a catalyst increases the rate of reaction, making it possible to operate at lower reaction temperatures as compared to thermal cracking.

The present invention, in one embodiment, is a catalytic composition comprising a basic material and less than 3 wt % of an acidic zeolite. Preferably the catalytic composition is substantially free of acidic zeolite. The term “catalytic composition” as used herein refers to the combination of catalytic materials that is contacted with an FCC feedstock in an FCC process. The catalytic composition may consist of one type of catalytic particles, or may be a combination of different types of particles. For example, the catalytic composition may comprise particles of a main catalytic material and particles of a catalyst additive. The combined composition should contain less than 3 wt % of acidic zeolite.

The catalytic compositions of the present invention provide a conversion of FCC feed stock of at least 10% at a catalyst-to-oil (CTO) ratio of 10 and a contact temperature below 700° C. Conversion is defined as (dry gas)+(LPG)+(Gasoline)+(Coke)=100—(Bottoms)—(LCO). Preferably the conversion is at least 20%, more preferably at least 30%.

The conversion, as defined above, should not exceed 70%, and preferably should be less than 60%, more preferably less than 55%.

By contrast, the traditional FCC processes use an acidic material, commonly an acidic zeolite, as the cracking catalyst. The acidic sites of the catalyst catalyze the cracking reaction via a two-electron mechanism. This mechanism favors the formation of high molecular weight olefins, which readily become cyclized to form cycloalkanes. The cycloalkanes in turn readily become dehydrogenated to form aromatic compounds.

This dehydrogenation reaction involves hydrogen transfer to olefins in the product mixture, thereby reducing the yield of desirable compounds such as propylene.

The reaction catalyzed by a basic catalyst is believed to proceed via a one-electron mechanism. This may be the reason why the formation of aromatics is reduced as compared to the cracking reaction catalyzed by an acidic catalyst. Thermal cracking also proceeds via a one-electron mechanism. However, thermal cracking requires very high temperatures, which thermodynamically favors the formation of aromatics as well as excessive coke. The purpose of the present invention is to provide catalytic compositions that permit “thermal” cracking to be carried out at riser exit temperatures below 600° C., preferably below 550° C., most preferably below 500° C. The actual reaction temperatures are higher than the riser exit temperatures. In so-called millisecond riser cracking the reaction temperature may need to be as high as 800° C.

It is possible to have a catalytic composition that has, in addition to its basic catalytic sites, also acidic sites. It may even be desirable to provide acidic sites to increase the overall catalytic activity of the catalyst. If acidic sites are present, however, the number of basic sites must be greater than the number of acidic sites. Also, the acidic sites preferably are not present in the form of acidic zeolitic material.

Methods for titrating the acidic sites and the basic sites of solid materials are described in “Studies in Surface Science and Catalysis, 51: New Solid Acids and Bases”, K. Tanabe, M. Misono, Y. Ono, H. Hattori, Kodansha Ltd. Tokyo (co-published by Kodansha Ltd. Tokyo and Elsevier Science Publishers B.V., Amsterdam) (hereinafter referred to as “Tanabe”).

The benchmark material is silica which, in the absence of additives or dopants, is considered “neutral” for purposes of the present invention. Any material having a more basic reaction to an indicator of the type described in Tanabe is in principle a basic material for purposes of the present invention.

As is clear from Table 2.4 of Tanabe, a solid material may have both basic and acidic sites. Basic materials suitable for the catalytic compositions of the present invention are those that have more basic sites than they possess acidic sites. The basic materials of the present invention may be mixed with acidic materials, provided that the sum total of basic sites of the composition is greater than the sum total of acidic sites.

Acidic zeolites as are commonly used in conventional FCC catalysts have so many strong acidic sites that, when used in even small amounts in combination with a basic material, the resulting catalyst is predominantly acidic. The catalytic compositions of the present invention preferably do not contain an acidic zeolite.

Materials suitable for use as catalytic compositions in the present invention include basic materials (both Lewis bases and Bronstedt bases), solid materials having vacancies, transition metals, and phosphates. It is desirable that the materials have a low dehydrogenating activity. Preferably, the catalytic compositions of the present invention are substantially free of components having a dehydrogenating activity. For example, it has been discovered, that compounds of several transition metals tend to have too strong a dehydrogenation activity to be useful in this context. Although they may possess the required basic character, the dehydrogenation activity of these materials results in an undesirably high coke yield and formation of too much aromatics. As a general rule, transition metals that tend to be present in or convert to their metallic state under FCC conditions have too high a dehydrogenation activity to be useful for the present purpose.

The basic material may be supported on a suitable carrier. For this purpose the basic material may be deposited on the carrier by any suitable method known in the art.

The carrier material may be acidic in nature. In many cases the basic material will cover the acidic sites of the carrier, resulting in a catalyst having the required basic character. Suitable carrier materials include the refractory oxides, in particular alumina, silica, silica-alumina, titania, zirconia, and mixtures thereof. The preferred carrier is alumina.

Suitable basic materials for use in the catalytic compositions of the present invention include compounds of alkali metals, compounds of alkaline earth metals, compounds of trivalent metals, compounds of transition metals, compounds of the Lanthanides, and mixtures thereof.

Suitable compounds include the oxides, the hydroxides and the phosphates of these elements.

A class of materials preferred as basic materials in the catalytic compositions of the present invention are mixed metal oxides, mixed metal hydroxides, and mixed metal phosphates. Cationic and anionic layered materials are suitable as precursors to mixed metal oxides.

Another class of preferred basic materials for the present invention are compounds of transition metals, in particular the oxides, hydroxides and phosphates. Preferred are compounds of transition metals that do not have a strong dehydrogenation activity. Examples of suitable materials include ZrO₂, Y₂O₃, and Nb₂O₅.

A preferred class of materials for use as basic catalytic compositions in the present invention are anionic clays, in particular hydrotalcite-like materials, in hydrotalcite-like anionic clays the brucite-like main layers are built up of octahedra alternating with interlayers in which water molecules and anions, more particularly carbonate ions, are distributed.

The interlayers may contain anions such as NO₃⁻, OH⁻, Cl⁻, Br⁻, I⁻, SO₄²⁻, SiO₃²⁻, CrO₄²⁻, BO₃²⁻, MnO₄⁻, HGaO₃²⁻, HVO₄²⁻, ClO₄⁻, BO₃²⁻, V₁₀O₂₈⁶⁻, monocarboxylates such as acetate, dicarboxylates such as oxalate, alkylsulfonates such as laurylsulfonate.

“True” hydrotalcite, that is hydrotalcites having magnesium as the divalent metal and alumina as the trivalent metal, is preferred for use in the present invention.

The catalytic selectivity of a hydrotalcite-like material (including hydrotalcite itself) may be improved by subjecting the hydrotalcite to heat deactivation. A suitable method for heat deactivating a hydrotalcite material comprises treating the material in air or steam for several hours, for example five to 20 hours, at a temperature of from 300 to 900° C., Heating causes the layered structure to collapse and amorphous material to be formed. Upon continued heating, a doped periclase structure is formed, in which some of the Mg²⁺ sites are filled with Al³⁺. In other words, vacancies are formed, which have been found to improve the selectivity of the catalytic material.

Extreme heat treatment will cause this material to segregate into a periclase and a spinel structure. The spinel structure is inactive as a catalyst. Significant spinel formation has been observed after heating a hydrotalcite material for four hours at 900° C.

Another preferred class of basic materials is the aluminum phosphates. Although certain aluminum phosphates are acidic, their properties can be modified with metal dopants. It will be understood that the aluminum phosphates suitable for use herein are those having a basic character, either as-is, or as a result of the addition of suitable dopants.

The activity and the selectivity of the above-mentioned materials may be adjusted by doping these materials with another metal. In general, most transition metals are suitable dopants for use in this context. Notable exceptions include those transition metals that have a dehydrogenating activity, such as nickel, and the platinum group metals. Fe and Mo have also been found to be unsuitable.

Preferred dopants include metal cations from Groups IIb, IIIb, IVb of the Periodic Table of elements, and the rare earth metals. Specifically preferred dopants include La, W, Zn, Zr, and mixtures thereof.

As mentioned previously, the catalytic compositions of the present invention may further comprise an acidic material, provided that the overall character of the catalyst remains basic. The presence of a material having acidic sites may be desirable in terms of improving the overall activity of the catalyst. Silica-magnesia is an example of a material having both basic and acidic sites. If more than 40% of the sites are acidic the overall character of the material tends to become acidic.

Suitable materials having acidic sites include silica sol, metal doped silica sol, and nano-scale composites of silica with other refractory oxides. Acidic zeolites are not suitable for incorporation into the catalytic materials of the present invention, because the acidic character of acidic zeolites is so strong as to easily overwhelm the basic character of the catalyst. For this reason the catalytic compositions of the present invention comprise less than 3 wt % acidic zeolite, and are preferably substantially free of acidic zeolite.

A suitable method for preparing a catalyst having a high attrition resistance is described in U.S. Pat. No. 6,589,902 to Stamires et al., the disclosures of which are incorporated herein by reference.

The catalytic compositions of the present invention preferably have a relatively high specific surface area, to compensate for their activity being lower than that of conventional FCC catalysts. Preferably the catalytic compositions have a specific surface area as measured by the BET method after steam deactivation at 788° C. for 5 hours of at least 60 m²/g, preferably at least 90 m²/g.

Another aspect of the present invention is an FCC process comprising the step of contacting an FCC feed stock with the catalytic composition of the present invention under FCC reaction conditions. The FCC feed stock may be VGO, hydrotreated VGO, atmospheric resid, the atmospheric resid feed, crude oil, shale oil, tar sand, and mixtures thereof.

The term “FCC process” as used herein refers to process conditions that are typical for conventional FCC processes. Specifically, the reaction temperature in the riser is less than about 600° C., preferably less than 550° C., more preferably less than 510° C.; the total pressure is less than 5 bar, with the hydrogen partial pressure being less than the total pressure. The conversion is less than 70%.

It will be understood that the term FCC process does not encompass hydrotreatment processes, which require elevated hydrogen pressures on the order of 100 bar or more. The term FCC process also does not encompass steam pyrolysis, which is carried out at temperatures above 600° C., and results in a conversion of more than 90%, typically (close to) 100%.

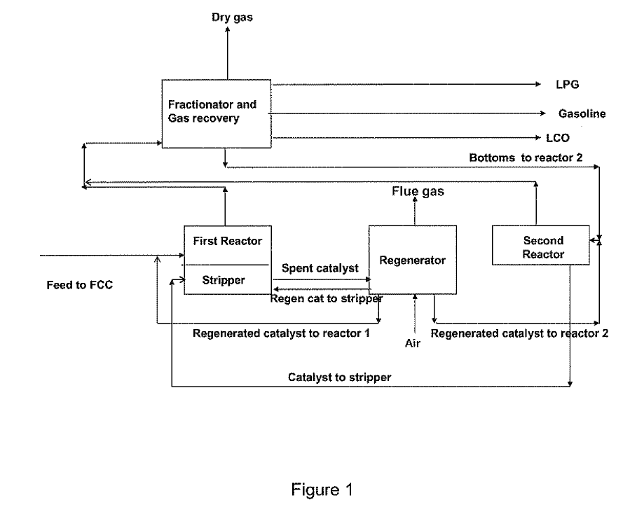

Another aspect of the present invention is a two-stage cracking process as illustrated in FIG. 1. The FCC feedstock may be, amongst others, VGO, hydrotreated VGO, atmospheric resid, hydrotreated vacuum resid, vacuum resid, hydrotreated vacuum resid, coker gasoil and hydrotreated coker gasoils, crude oil, shale oil, tar sand, and mixtures thereof. Preferred feedstocks are VGO and atmospheric resid.

The first stage is preferably performed at low cracking temperature as then the LCO yield is maximized while its aromatics content is minimized. The aromatics content of the bottoms from the first stage is low and they can be easily cracked in a second stage. This can be done by recycling to the first stage, but more preferably the bottoms of the first stage are cracked in a second stage at a higher temperature than in the first stage. In this way the conversion of the FCC feed, the LCO yield and LCO cetane number are maximized.

The temperature in the first cracking stage should be kept as low as possible to reduce the formation of aromatics. In a conventional FCC unit stripping of the hydrocarbon vapors deteriorates, as the cracking temperature is reduced because the stripping temperature is completely determined by the cracking temperature. If stripping becomes unacceptably low, hydrocarbon breakthrough to the regenerator occurs, which will cause temperature runaway and excessive catalyst deactivation. To enable a low cracking temperature without sacrificing stripping in the preferred embodiment facilities are provided to increase stripping temperature by routing some hot regenerated catalyst to the stripper bed.

In this two-stage process at least one of the two stages is carried out in an FCC reactor. One of the stages may be carried out in a coker, or in a hydrocracking unit. In a preferred embodiment both stages are carried out in an FCC unit.

The catalysts used in the two stages may be the same, or may be different, provided that the process comprises at least one FCC stage in which the catalytic composition of the present invention is used. For example, one stage may be carried out with a conventional, zeolite-comprising catalyst, while the other stage is carried out with the catalytic composition of the present invention. It is preferred that the catalyst of the first stage is the catalytic composition of the present invention.

Preferably only the bottoms product of the first stage is subjected to the second stage cracking process. To this end, the product of the first stage is subjected to a separation step whereby the bottoms product is separated from the other fractions (gasoline, LCO, dry gas, etc.). In one embodiment the bottoms product of the first stage is simply mixed with the feed to the first stage. In this embodiment the second stage consists of a recycle stream of bottoms product from the first stage into the feed of the reactor.

In a preferred embodiment the second stage is carried out in a separate reactor. This has the advantage that the second stage can be carried out under reaction conditions that are different from those of the first stage. Specifically, it is desirable to carry out the first stage at a lower reaction temperature than the second stage. By way of example, if both stages are FCC reactors, the first stage could be carried out at a reaction temperature in the range of 460 to 500° C., and the second stage at a reaction temperature in the range of 530 to 570° C. If one of the stages is a hydrocracking process, it is understood that this stage will be carried out under conditions known in the art in terms of partial hydrogen pressure, reaction temperature, contact time, etc.

As mentioned above, the two stages could employ the same or different catalysts. The advantage of using the same catalyst in both stages is that both catalysts can be stripped and regenerated in a common stripper and regenerator, which reduces the capital investment required for this process. On the other hand, the use of different catalysts in the two stages increases the flexibility of the process and allows for further optimization in terms of bottoms yield and aromatics content of the various product streams.

As in conventional FCC processes, hydrocarbons are stripped off the catalyst in the stripper. Next, coke formed on the catalyst is burned off in the regenerator. Hot catalyst material is recycled into the reactor. It may be desirable to adjust the stripper temperature between 520 to 600° C. by routing some catalyst from the regenerator to the stripper.

Yet another aspect of the present invention is the gasoline fraction obtained with the process of this invention. The gasoline fraction is characterized in having a low aromatics content as compared with the gasoline fraction obtained with a conventional FCC process.

A further aspect of the present invention is the LCO fraction obtained with the process of this invention. The LCO fraction is characterized in having a low aromatics content as compared with the gasoline fraction obtained with a conventional FCC process.

A further aspect of the present invention is the heavy cycle oil (HCO) fraction obtained with the process of this invention. The HCO fraction is characterized in having a low aromatics content as compared with HCO fraction obtained with a conventional FCC process.

A further aspect of the present invention is the gasoline fraction obtained with the process of this invention. The HCO fraction is characterized in having a low aromatics content as compared with the gasoline fraction obtained with a conventional FCC process.

### Examples

In the following examples the catalytic selectivity of several basic catalytic compositions according to the present invention is compared to that of a commercially available acidic FCC catalyst.

The commercially available FCC catalyst was a conventional Y-zeolite catalyst with an alumina matrix.

Composition FCC catalyst:

| | |
|---|---|
| Al₂O₃ (wt %) | 37.5 |
| SiO₂ (wt %) | 57.0 |
| Na₂O (wt %) | 0.35 |
| RE₂O₃ (wt %) | 2.55 |
| Fe₂O₃ (wt %) | 1.02 |
| TiO₂ (wt %) | 0.52 |
| Sb (ppm) | 416 |
| Ni (ppm) | 1767 |
| V (ppm) | 1988 |

Physical properties FCC catalyst:

| | |
|---|---|
| AAl | 3.5 |
| SA-BET (m²/g) | 152 |
| SA-Meso (m²/g) | 53 |
| PV-micro (ml/g) | 0.046 |

Hydrotalcite was prepared following the procedure described in U.S. Pat. No. 6,589,902. The Mg to Al ratio was 4:1. The hydrotalcite was calcined at 600° C. for one hour.

As desired, metal ions were impregnated into the hydrotalcite by rehydrating the calcined hydrotalcite in an aqueous solution containing a salt of the desired metal.

Clay was kaolin clay obtained from Thiele Kaolin Company of Sandersville, Ga. (USA). The clay was calcined at 1000° C.

Aluminum phosphate materials were prepared as described in U.S. Pat. 6,797,155 B1. After precipitation at a pH in the range of 7-12, the precipitate was aged at 100 to 200° C. for up to 2 days.

The precipitate was separated from the liquid by filtration, then dried, and calcined at 540° C. As desired, the aluminum phosphate was modified by metal impregnation, as described above for hydrotalcite.

The catalytic activity and selectivity of the various materials was in a micro-activity reactor. As feed stock Kuwait VGO was used. All test reactions were performed at a contact temperature of 500° C.

Characteristics of Kuwait VGO

| SIMDIST | ° C. |
|---|---|
| C₅ wt % | 360 |
| 10 wt % | 374 |
| 20 wt % | 396 |
| 30 wt % | 415 |
| 40 wt % | 432 |
| 50 wt % | 450 |
| 60 wt % | 470 |
| 70 wt % | 489 |
| 80 wt % | 511 |
| 90 wt % | 537 |
| 95 wt % | 559 |
| SATURATES, wt % | 60.0 |
| MONO-AROMATICS, wt % | 16.0 |
| DI-AROMATICS, wt % | 10.1 |
| DI+-AROMATICS/POLARS, wt % | 14.8 |
| SULFUR, ppm wt | 29040 |
| NITROGEN, ppm wt | 996 |
| CCR, wt % | 0.54 |

The reaction product was subjected to distillation. The light cycle oil fraction (LCO fraction) was separated and analyzed for total aromatics content using calibrated gas chromatography. The coke yield was determined by analyzing the CO and CO₂ contents of the effluent of the regenerator under oxidizing conditions.

### Example 1

The commercial FCC catalyst, a sample of the clay material, and a sample of the hydrotalcite material were tested in the test reactor described above. The feed conversion rate was varied by varying the catalyst-to-oil (CTO) ratio. For each test run the reaction product was collected. The LCO fraction was analyzed for aromatics content. Standard LCO cutpoint of 221 to 350° C. was used. The results are summarized in Table 1.

TABLE 1

| | | | FCC | | | FCC |
|---|---|---|---|---|---|---|
| | Clay | HTC | Catalyst | Clay | HTC | Catalyst |
| Bottoms yield, | 30 | 30 | 30 | 20 | 20 | 20 |
| wt % | | | | | | |
| LCO Aromatics | 58 | 42 | 58 (*) | 60 | 45 | 70 |
| content, wt % | | | | | | |

(*) estimate

Both the clay material and the hydrotalcite material produced an LCO fraction with significantly lower aromatics content than that produced by the conventional FCC catalyst.

Decreasing the bottoms yield by increasing the CTO ratio dramatically increased the aromatics content of the LCO fraction in the case of the conventional FCC catalyst. For example the aromatics content of LCO increased from 70 wt % to above 90 wt % when the bottoms yield dropped from 20 to 10 wt %, The increase in aromatics was more modest for the clay and hydrotalcite materials. Within the bottoms yield range of 60 to 20 wt % only a very moderate increase in LCO aromatics content was observed.

The performance of Si—Mg, a conventional FCC catalyst, and the Mg/Alhydrotalcite were compared. The results are presented in table 2.

TABLE 2

| | Si—Mg | Si—Mg | Si—Mg | FCC | FCC | FCC | HTC | HTC | HTC | HTC |
|---|---|---|---|---|---|---|---|---|---|---|
| CTO | 3.49 | 5.99 | 9.98 | 3.49 | 5.99 | 9.98 | 3.49 | 5.99 | 9.98 | 19.86 |
| Gasoline | 36.71 | 47.00 | 49.24 | 46.79 | 49.76 | 46.63 | 8.91 | 13.08 | 19.35 | 25.28 |
| LCO | 31.50 | 25.14 | 22.00 | 23.77 | 17.72 | 12.18 | 25.79 | 28.32 | 31.62 | 31.11 |
| Bottoms | 21.21 | 7.22 | 3.17 | 8.03 | 4.50 | 2.98 | 57.47 | 47.88 | 33.57 | 21.36 |
| Coke | 3.95 | 6.47 | 8.88 | 4.33 | 7.24 | 10.97 | 4.36 | 6.35 | 9.08 | 12.32 |
| LCO/arom | 48.18 | 59.68 | 64.38 | 66.07 | 81.00 | 94.51 | 34.24 | 36.04 | 38.05 | 41.39 |
| HCO/arom | 33.09 | 52.05 | 68.43 | 67.64 | 95.81 | 100.00 | 43.92 | 41.66 | 36.99 | 33.57 |

CTO is the catalyst/oil ratio.
Gasoline is the amount of product (in wt %) having a boiling point in the range above the boiling point of n-pentane to 221° C.
LCO (Light Cycle Oil) is the amount of product (in wt %) having a boiling point in the range of 221 to 340° C.
Bottoms is the amount of product (in wt %) having a boiling point above 340° C.
Coke is the amount of coke formed on the catalyst.
HCO (heavy cycle oil) is the fraction of the bottoms having a boiling point range of 340 to 496° C.
LCO/arom is the aromatics content of the light cycle oil fraction
HCO/arom is the aromatics content of the heavy cycle oil fraction.

### Example 2

Aluminum phosphate materials prepared as described above were modified by impregnation with La, Zn, and Zr, respectively. Their properties are summarized in Table 3.

TABLE 3

| | SA | M | Al | P |
|---|---|---|---|---|
| | (m²/g) | (wt %) | (wt %) | (wt %) |
| AlPOx | 316 | 13 | 28 | 3 |
| LaAlPOx | 156 | 29 | 23 | 7 |
| ZnAlPOx | 200 | 13 | 38 | 1 |
| ZrAlPOx | 126 | 31 | 15 | 5 |

SA is the specific surface area, as measured by the BET method
M is the amount of dopant metal
Al is the amount of aluminum
P is the amount of phosphorus

As feedstock Crown VGO was used.

Characteristics of Crown VGO

| SIMDIST, | ° C. |
|---|---|
| 10 wt % | 320 |
| 20 wt % | 353 |
| 30 wt % | 374 |
| 40 wt % | 393 |
| 50 wt % | 414 |
| 60 wt % | 437 |
| 70 wt % | 457 |
| 80 wt % | 476 |
| 90 wt % | 512 |
| 95 wt % | |
| FBP | 561 |
| SATURATES, wt % | 62.4 |
| MONO-AROMATICS, wt % | 17.0 |
| DI-AROMATICS, wt % | 11.1 |
| DI+-AROMATICS/POLARS, wt % | 9.4 |
| SULFUR, ppm wt | 6400 |
| NITROGEN, ppm wt | 1153 |
| CCR, wt % | 0.14 |

A silica magnesia material was prepared according to example 1 of U.S. Pat. No. 2,901,440, with the exception that no HF was added before drying.

The catalyst materials were tested for their cracking activities, as described in Example 1. MAT experiments were carried out at contact temperatures of 500 and 550° C.

The LCO and HCO fractions were collected and analyzed for their aromatics content using two-dimensional gas chromatography.

The results are summarized in Table 4

TABLE 4

| Temp | ZnAlPOₓ | ZnAlPOₓ | LaAlPOₓ | LaAlPOₓ | ZrAlPOₓ | ZrAlPOₓ | CeAlPOₓ | CeAlPOₓ |
|---|---|---|---|---|---|---|---|---|
| CTO | 11 | 10 | 11 | 19 | 10 | 19 | 11 | 5.7 |
| Dry gas | 2.5 | 4.3 | 2.5 | 3.1 | 3.5 | 2.7 | 3.3 | 2.1 |
| LPG | 3.4 | 5.4 | 3.6 | 4.9 | 4.1 | 4.6 | 6.7 | 4.1 |
| Gasoline | 14.6 | 17.2 | 15.2 | 20.8 | 16.7 | 18.1 | 25.5 | 15.8 |
| LCO | 29.8 | 27.7 | 30.3 | 33.9 | 30.8 | 31.9 | 28.4 | 29.6 |
| Bottoms | 38.8 | 36.4 | 42.1 | 28.7 | 38.7 | 35.0 | 17.1 | 42.1 |
| Coke | 11.0 | 9.1 | 6.4 | 8.6 | 6.2 | 7.6 | 19.0 | 6.2 |
| LCO/arom | 35.4 | 35.6 | 34.0 | 35.9 | 34.9 | 35.4 | 54.6 | 44.1 |
| HCO/arom | 37.0 | 40.0 | 36.8 | 39.1 | 39.9 | 35.9 | 36.3 | 36.0 |

Temp is de contact temperature (in ° C.).
CTO is the catalyst/oil ratio.
Dry gas is the amount of dry gas in the product stream (in wt %).
LPG is the amount of liquefiable gas in the product stream (in wt %).
Gasoline is the amount of product (in wt %) having a boiling point in the range above the boiling point of n-pentane to 221° C.
LCO (Light Cycle Oil) is the amount of product (in wt %) having a boiling point in the range of 221 to 340° C.
Bottoms is the amount of product (in wt %) having a boiling point above 340° C.
Coke is the amount of coke formed on the catalyst.
HCO (heavy cycle oil) is the fraction of the bottoms having a boiling point range of 340 to 496° C.
LCO/arom is the aromatics content of the light cycle oil fraction
HCO/arom is the aromatics content of the heavy cycle oil fraction.

The results show that doping aluminum phosphate with Zn, La, or Zr resulted in a material acting as a basic catalyst. The catalytic activity was low as compared to conventional FCC catalysts, thus requiring a rather high CTO ratio. The aromatic contents of both the LCO and the FICO fractions were desirably low.

Doping aluminum phosphate with Ce resulted in a catalyst tending more towards acidic characteristics, having a higher catalytic activity, and resulting in a higher aromatics content of the LCO fraction.

### Example 3

Hydrotalcite was prepared following the procedure described in U.S. Pat. No. 6,589,902. The Mg to Al ratio was 4:1. The hydrotalcite was calcined at 600° C. for one hour. As desired, metal ions were impregnated into the hydrotalcite by rehydrating the calcined hydrotalcite in an aqueous solution containing a salt of the desired metal.

A hydrotalcite-type Zn/Al mixed oxide was prepared using the same procedure, but replacing Mg with Zn.

The materials were tested in a microactivity tester (MAT) as described above. The contact temperature was 500° C. The results are summarized in Table 5.

TABLE 5

| | ZnAlMo1 | ZnAlW2 | ZnAlV3 | MgAlFeW4 | MgAlFeV5 | MgAlV6 | MgAlMo7 | Mg [symbol] |
|---|---|---|---|---|---|---|---|---|
| CTO | 11.19 | 11.18 | 11.18 | 11.18 | 11.19 | 11.18 | 11.18 | 11. [symbol] |
| Gasoline | 17.15 | 17.68 | 17.08 | 16.47 | 15.62 | 18.49 | 16.71 | 19. [symbol] |
| LCO | 30.01 | 33.49 | 30.29 | 30.61 | 28.96 | 32.36 | 30.66 | 33. [symbol] |
| Bottoms | 31.56 | 33.30 | 25.06 | 26.10 | 23.67 | 26.27 | 26.21 | 26. [symbol] |
| Coke | 15.81 | 9.17 | 21.02 | 20.43 | 25.40 | 16.21 | 19.01 | 12. [symbol] |
| LCO/arom | 42.47 | 42.87 | 43.87 | 38.87 | 39.57 | 41.10 | 41.80 | 37. [symbol] |
| HCO/arom | 37.14 | 36.32 | 40.58 | 39.05 | 40.66 | 42.98 | 40.66 | 41. [symbol] |

1Contained 1% Mo
2Contained 1% W
3Contained 1% V
4Contained 4% Fe, 1% W
5Contained 4% Fe, 1% V
6Contained 5% V
7Contained 5% Mo
8Contained 5% W
9Contained 5% P
10Contained 1% Zr [symbol]
indicates data missing or illegible when filed

Mg/Al hydrotalcite-based catalytic compositions tend to produce lower LCO aromatics contents than Zn/Al hydrotalcite based catalytic compositions.

### Example 4

Hydrotalcite materials doped with a range of metal ions were compared for coke make in the MAT. Materials doped with Fe, Mo, and Fe+Mo had significantly higher coke yields than materials doped with W, V, P, or Zr.

### Example 5

In the following examples the catalytic selectivity of HTC basic catalyst according to the present invention is evaluated in a Micro Fluid Simulation Test, the MST. The MST is deploys a fixed fluid bed micro-reactor which is tuned to provide realistic results in line with those from commercial FCC Units. More details can be found in “A Microscale Simulation Test for Fluid Catalytic Cracking, P. O'Connor, M. B. Hartkamp, ACS Symposium Series No. 411, 1989. The experiments were conducted at several cracking temperatures ranging from 480° C. to 560° C.

As feedstocks a vacuum gasoil, Crown VGO and an atmospheric residue, Huabei A R, were used.

TABLE 1
Characteristics of Crown VGO and Huabei Atmospheric Residue.

| | Crown VGO | Huabei AR |
|---|---|---|
| IBP, ° C. | 228 | 231 |
| 5 WT %, ° C. | 292 | 320 |
| 10 WT % | 320 | 353 |
| 30 WT % | 374 | 423 |
| 50 WT % | 414 | 488 |
| 70 WT % | 457 | 604 |
| 90 WT % | 512 | 732 |
| FBP, o C. | 561 | 761 |
| Saturates, wt % | 62.4 | 74.8 |
| Mono-aromatics, wt % | 17.0 | 9.3 |
| Di-aromatics, wt % | 11.1 | 6.2 |
| Di+-aromatics/Polars, wt % | 9.4 | 9.7 |
| Sulfur, ppm wt | 6400 | 2599 |
| Nitrogen, ppm wt | 1153 | 2643 |
| Conradson Carbon Residue, wt % | 0.14 | 5.27 |
| Density at 15° C. | 0.8998 | 0.8976 |

Hydrotalcite was prepared following the procedure described in U.S. Pat. No. 6,589,902. The Mg to Al ratio was 4:1. The hydrotalcite was calcined at 600° C. for one hour and used as catalyst in the experiments.

The reaction products were subjected to distillation. The LCO and HCO fractions were collected and analyzed for their aromatics content using two-dimensional gas chromatography. The dry gas, LPG and gasoline fractions were analyzed by GC.

The coke yield was determined by analyzing the CO and CO₂ contents of the effluent of the regenerator under oxidizing conditions.

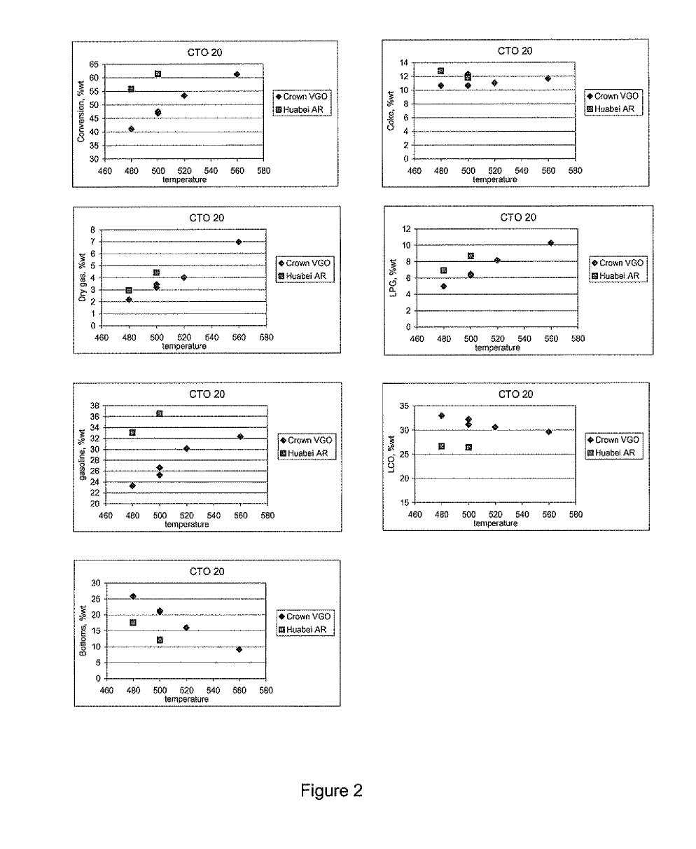

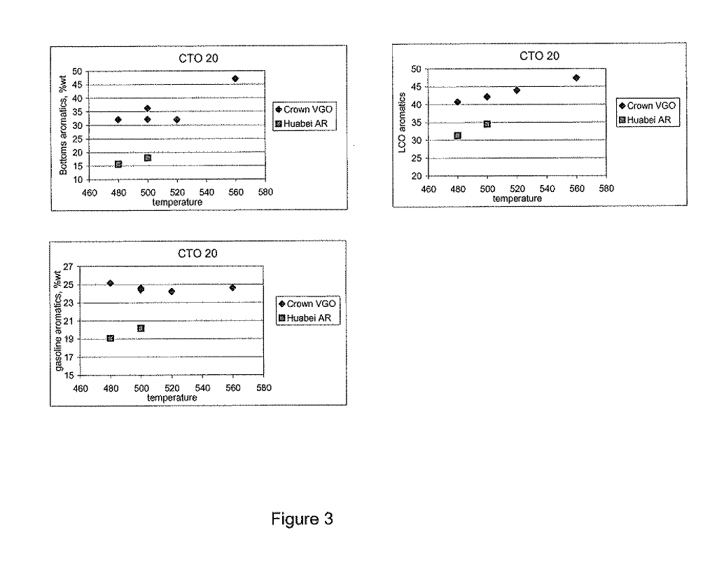

The yield structure is shown in FIG. 2, while the aromatics content of gasoline, LCO and Bottoms are shown in FIG. 3. The comparisons are made at a CTO of 20 wt/wt.

Temperature is the catalyst bed temperature in ° C.

CTO is the catalyst/oil ratio in wt/wt.

Dry gas is the amount of dry gas in the product stream (in wt %).

LPG is the amount of liquefiable gas in the product stream (in wt %).

Gasoline is the amount of product (in wt %) having a boiling point in the range above the boiling point of pentane to 221° C.

LCO (Light Cycle Oil) is the amount of product (in wt %) having a boiling point in the range of 221 to 350° C.

Bottoms is the amount of product (in wt %) having a boiling point above 350° C.

Coke is the amount of coke (in wt %) produced.

The results in FIG. 2 show that the LCO yield is highest at low cracking temperature. The bottoms yield is then also highest. Note that the LCO yield is then nearly 35 wt % for Crown VGO feed at a low cracking temperature of 480° C.

The corresponding LCO aromatics content is about 40 wt % The Bottoms yield is high at some 25 wt % while its aromatics content is low at around 31 wt %. This low aromatics bottoms can be easily cracked in a second stage.

For the Huabei atmospheric residue the LCO yield is about 26 wt %, the Bottoms yield around 18 wt %, the LCO aromatics content is some 31 wt % and the Bottoms aromatics content some 15 wt % at the same cracking conditions.

Conventional commercial FCC cracking is conducted in the cracking temperature range of 500 to 560° C. using a conventional acidic type zeolite containing catalyst.

This is best simulated in the MST by using aforementioned zeolite containing catalyst, a bed temperature of some 560° C. and a CTO of 3 to 4 wt %. The LCO yield is then less than 20 wt % and the LCO aromatics content above 80 wt %.

Hence by using a basic catalyst at mild conditions the LCO yield can be substantially reduced while its aromatics content is greatly reduced. The reduction in bottoms conversion is compensated by cracking the bottoms from the first stage in a second stage.

1. Catalytic compositions for use in an FCC process, said compositions comprising a basic material, wherein said catalytic compositions are substantially free of acidic zeolite.

2. A catalytic composition according to claim 1, which is substantially free of components having a dehydrogenating activity.

3. A catalytic composition according to claim 1 having sufficient catalytic activity to provide a conversion of FCC feedstock of at least 30% at a CTO ratio of 10 and a reaction temperature below 600° C.

4. The catalytic composition according to claim 1, wherein the basic material:
a. is selected from the group consisting of compounds of alkali metals, compounds of alkaline earth metals, compounds of trivalent metals, compounds of transition metals, and mixtures thereof,
b. is the oxide, the hydroxide or the phosphate of a transition metal, an alkali metal, an earth alkaline metal, or a transition metal, or a mixture thereof;
c. comprises an alkali metal compound;
d. comprises an alkaline earth metal compound;
e. is a mixed metal oxide;
f. comprises a compound of a transition metal;
g. is a hydrotalcite;
h. is an aluminum phosphate;
i. is doped with a metal cation;
j. is supported on a carrier material;
k. any combination of j) with a)-i);
l. any combination of i) with a)-h), and/or
m. any combination of a)-j).

5-9. (canceled)

10. The catalytic composition according to claim 4 wherein the compound of a transition metal is selected from the group consisting of ZrO2, Y2O3, Nb2O5, and mixtures thereof.

11-14. (canceled)

15. The catalytic composition according to claim 4 wherein the dopant metal cation is selected from metals of Group IIb, Group IIIb, Group IVb, the rare earth metals, and mixtures thereof.

16. The catalytic composition according to claim 4 wherein the dopant metal is selected from the group consisting of La, Zn, Zr, and mixtures thereof.

17. The catalytic composition according to claim 4 wherein the carrier is a refractory oxide.

18. The catalytic composition according to claim 8 wherein the carrier is selected from alumina, silica, silica-alumina, titania, and mixtures thereof.

19. The catalytic composition of any one of claim 1 or 4 further comprising a material having acidic sites.

20. The catalytic composition of claim 10 wherein the material having acidic sites is selected from the group consisting of silica sol, metal doped silica sol, and nano-scale composites of silica with other refractory oxides.

21. An FCC process comprising the step of contacting an FCC feedstock with the a catalytic composition under FCC reaction conditions, wherein said catalytic composition comprises a basic material, and wherein said catalytic compositions are substantially free of acidic zeolite.

22. The process of claim 12 wherein the FCC feedstock is selected from the group consisting of vacuum gas oil, hydrotreated vacuum gas oil, atmospheric resid feed, crude oil, shale oil, tar sand, and mixtures thereof.

23. The process of claim 12, which is carried out at a reaction temperature in the range of 400-600° C.

24. A two-stage cracking process for cracking a feedstock selected from vacuum gasoils, hydrotreated vacuum gasoils, coker gasoils, atmospheric residues, vacuum residues and the hydrotreated products thereof, characterized in that at least one of the stages is a fluid catalytic cracking process in which the catalytic composition comprises a basic material, and wherein said catalytic composition is substantially free of acidic zeolite.

25. A process according to claim 15 in which the first stage is operated at a reaction temperature of i) 460 to 900° C., ii) between 460 to 600° C., or iii) between 460 to 500° C.

26. A process according to claim 15 in which both stages are FCC processes, and the second stage is operated at a reaction temperature of i) 480 to 900° C., ii) between 500 to 600° C., or iii) between 530 to 570° C.

27. A process according to claim 17, in which said FCC process comprises a stripper and a regenerator and the stripper temperature is adjusted between 520 to 600° C. by routing some catalyst from the regenerator to the stripper.

28-29. (canceled)

30. A cracking process according to claim 15 wherein:
a. one of the stages is a hydrocracking process;
b. one of the stages is a hydrocracking process and the first stage is a fluid catalytic cracking process;
c. one of the stages is a hydrocracking process and the first stage is a hydrocracking process; or
d. both of the stages are fluid catalytic cracking processes.

31-32. (canceled)

33. An LCD, HCO, and/or gasoline fraction obtained with the process of any one of claim 12 or 15.

34-35. (canceled)

36. The process according to claim 12 wherein said catalytic composition is substantially free of components having a dehydrogenating activity.

37. The process according to claim 12 wherein said catalytic composition has sufficient catalytic activity to provide a conversion of FCC feedstock of at least 30% at a CTO ratio of 10 and a reaction temperature below 600° C.

38. The process according to claim 12 wherein the basic material of said catalytic composition:
a) is selected from the group consisting of compounds of alkali metals, compounds of alkaline earth metals, compounds of trivalent metals, compounds of transition metals, and mixtures thereof;
b) is the oxide, the hydroxide or the phosphate of a transition metal, an alkali metal, an earth alkaline metal, or a transition metal, or a mixture thereof;
c) comprises an alkali metal compound;
d) comprises an alkaline earth metal compound;
e) is a mixed metal oxide;
f) comprises a compound of a transition metal;
g) is a hydrotalcite;
h) is an aluminum phosphate;
i) is doped with a metal cation;
j) is supported on a carrier material;
k) any combination of j) with a)-i);
l) any combination of i) with a)-h); and/or,
m) any combination of a)-j).

39. The process according to claim 12 wherein the compound of a transition metal of said catalytic composition is selected from the group consisting of ZrO2, Y2O3, Nb2O5, and mixtures thereof; and/or wherein the dopant metal cation is selected from metals of Group IIb, Group IIIb, Group IVb, the rare earth metals, and mixtures thereof; and/or wherein the carrier is a refractory oxide.

40. The catalytic composition according to claim 24 wherein the carrier is selected from alumina, silica, silica-alumina, titania, and mixtures thereof; and/or wherein the dopant metal is selected from the group consisting of La, Zn, Zr, and mixtures thereof.

41. The catalytic composition of any of claim 12 or 23 further comprising a material having acidic sites.

42. A process according to claim 15 in which the catalyst in one of the stages is a traditional acidic zeolite-containing cracking catalyst.

43. The process according to claim 15 wherein the catalytic composition used in one or more of the fluidized catalytic cracking stages is substantially free of components having a dehydrogenating activity,

44. The process according to claim 15 wherein the catalytic composition used in one or more of the fluidized catalytic cracking stages is substantially free has sufficient catalytic activity to provide a conversion of FCC feedstock of at least 30% at a CTO ratio of 10 and a reaction temperature below 600° C.,

45. The process according to claim 15 wherein the basic material of said catalytic composition:
a) is selected from the group consisting of compounds of alkali metals, compounds of alkaline earth metals, compounds of trivalent metals, compounds of transition metals, and mixtures thereof;
b) is the oxide, the hydroxide or the phosphate of a transition metal, an alkali metal, an earth alkaline metal, or a transition metal, or a mixture thereof;
c) comprises an alkali metal compound;
d) comprises an alkaline earth metal compound;
e) is a mixed metal oxide;
f) comprises a compound of a transition metal;
g) is a hydrotalcite;
h) is an aluminum phosphate;
i) is doped with a metal cation;
j) is supported on a carrier material;
k) any combination of j) with a)-i);
l) any combination of i) with a)-h); and/or,
m) any combination of a)-j).

46. The process according to claim 30 wherein the compound of a transition metal of said catalytic composition is selected from the group consisting of ZrO2, Y2O3, Nb2O5, and mixtures thereof; and/or wherein the dopant metal cation is selected from metals of Group IIb, Group IIIb, Group IVb, the rare earth metals, and mixtures thereof; and/or wherein the carrier is a refractory oxide.

47. The process according to claim 30 wherein the carrier is selected from alumina, silica, silica-alumina, titania, and mixtures thereof; and/or wherein the dopant metal is selected from the group consisting of La, Zn, Zr, and mixtures thereof.

45. The process according to claim 30 wherein said catalytic composition comprises a material having acidic sites.
